(19) United States
(12) Patent Application Publication
(10) Pub. No.: US 2004/0170458 A1
(43) Pub. Date: Sep. 2, 2004

(54) Decorating means, decoration and method for decorating ceramic or vitreous products

(76) Inventor: Vincenzo Carbone, Sassuolo (IT)

Correspondence Address: NIXON & VANDERHYE, PC, 1100 N GLEBE ROAD, 8TH FLOOR, ARLINGTON, VA, 22201-4714, US

(21) Appl. No.: 10/479,886

(22) PCT Filed: Jun. 7, 2002
(86) PCT No.: PCT/IB02/02074

(30) Foreign Application Priority Data
Jun. 8, 2001 (IT) MO2001A000119

(51) Int. Cl. G06K 3/00

(52) U.S. Cl. 400/61

(57) ABSTRACT

Decorating means for ceramic or vitreous products that are suitable for being applied to said products by means of digital printing techniques comprise colouring means that are suitable for colouring said decorating means, binding means that are suitable for keeping said colouring means united, said decorating means having no flux substances. Decoration for decorating ceramic or vitreous products, comprising decorative motif means applied to support means by means of digital printing techniques said decorative motif means being created by decorating means that have no flux substances. A method for decorating ceramic or vitreous products by means of digital printing techniques, comprising applying decorating means to said products, said decorating means comprising colouring means that are suitable for colouring said decorating means and binding means that are suitable for keeping said colouring means united, said decorating means having no flux substances.

The invention relates to decorating means and decorations for decorating ceramic or vitreous products, for example ceramic tiles or glass slabs, and a method for decorating ceramic or vitreous products using said decorating means.

Methods exist in the prior art for the decoration of ceramic or vitreous products that use techniques of electrical reproduction to apply a decorating product to said products, for example a toner, which is subsequently fixed to the product during a firing process.

The toner must have an appropriate composition, for example the composition indicated in WO9839272, comprising pigments that resist fire, flux and binding resin, according to a set weight ratio.

The fire-resistant pigments are substances that are suitable for giving the toner the required colours; the flux enables the pigments to be fixed in the final decoration as the flux comprises substances that melt at firing temperature to incorporate the pigments in a molten mass that is designed to solidify during subsequent cooling; lastly, the binder enables the pigments and the fluxes to bind before firing.

One defect of the toner described in WO9839272 is that the composition of the toner, and in particular the type of flux and its quantity, must be appropriately chosen according to the type of pigment used and the firing temperature of the product to be decorated. In other words, the relative firing temperature for a given product is set and only one mixture of pigments and flux is set that enables the required aesthetic effects to be obtained at the preset firing temperature. It is thus necessary to store a wide range of different types of toner that are suitable for decorating different supports at different firing temperatures, which involves high costs for managing and storing the materials and may lead to an unsuitable toner being used for a given use.

A further defect of the toner described in WO9839272 is that it requires a quantity of flux varying between 10% and 30% in weight, which limits the quantity of other ingredients such as pigments, binding resins, agents controlling electrostatic charge, etc. In fact, by using for example 30% flux in weight the quantity of the other ingredients cannot exceed 70% toner in weight; if one wishes to obtain a particularly intense colour the quantity of pigments that can be added to 70% toner in weight may not be sufficient to ensure significant quality results. The toner described in WO9839272 is therefore sometimes unsuitable for providing results that are satisfactory from a qualitative point of view.

One aim of this invention is to improve the decorating means, the decorations and the methods for decorating ceramic or vitreous products.

A further aim of this invention is to provide decorating means and decorations that are suitable for decorating ceramic or vitreous products, and methods for applying said products, which means have great flexibility, in other words they can be used without significant modifications with different supports and at different firing temperatures.

Another further aim of this invention is to provide decorating means and decorations for decorating ceramic or vitreous products, and methods for applying said products that are capable of ensuring high-quality final results.

A first aspect of this invention provides decorating means for ceramic or vitreous products that are suitable for being applied to said products by means of digital printing techniques comprising colouring means that are suitable for colouring said decorating means, binding means that are suitable for keeping said colouring means united, characterised in that said decorating means have no flux substances.

In a preferred embodiment, said flux substances are associated with said decorating means on said products.

In a further preferred embodiment, the flux substances are applied to the products before the decorating means are applied to said products.

In a further preferred embodiment, the flux substances are applied to said products after the decorating means have been applied to said products.

In yet another preferred embodiment the decorating means are applied to products that are to be decorated by interposing support means, such as a sheet, which means can be removed before firing or which can decompose during firing.

This aspect of the invention enables highly flexible decorating means to be obtained, in other words it enables means to be obtained that are suitable for decorating a wide range of products that are subject to firing processes at different temperatures. In fact, in order to apply the same colour to different types of product to be subjected to firing-processes at different temperatures the same decorating means can be used by combining them with different flux substances or with different quantities of the same flux substance, depending on the type of product and the relative firing temperature.

This enables a smaller number of decorating means to be stored because combining them with different flux substances or with the same flux substance in different quantities enables virtually to decorate all the products that a ceramics plant normally manufactures. In this way it is possible to simplify warehouse and materials management and to significantly reduce management and storage costs and the probability of error linked to the use of the incorrect decorating means.

Furthermore, this aspect of the invention enables a larger quantity of substances other than the flux substances to be incorporated into the decorating means so as to adapt the decorating means to the needs of the ceramic products manufacturer. For example, it is possible to create decorating means containing a high level of colouring means to obtain a product that is decorated with intense and pronounced colouring. This enables the final quality of ceramic or vitreous products to be improved.

A second aspect of the invention provides a decoration for decorating ceramic or vitreous products, comprising decorative motif means applied to support means by means of digital printing techniques characterised in that said decorative motif means are made with decorating means that have no flux substances.

In a preferred embodiment, the decorating means comprise colouring means that are suitable for colouring the decorating means and binding means that are suitable for keeping the colouring means united.

In a further preferred embodiment, the flux substances, comprising, for example, dry ceramic glaze, are associated with the decorative motif means after the latter have been associated with support means.

This aspect of the invention enables decorations to be obtained that are created with decorating means provided with considerable flexibility because their composition is not limited by the presence of a specific flux substance that is suitable for decorating only one type of product at a set firing temperature.

A third aspect of this invention provides a method for decorating ceramic or vitreous products by means of digital printing techniques, comprising applying decorating means to said products, said decorating means comprising colouring means that are suitable for colouring said decorating means and binding means that are suitable for keeping said colouring means united, characterised in that said decorating means have no flux substances.

In a preferred embodiment, the method furthermore comprises coating the flux substances on products separately from the decorating means.

This aspect of the invention enables a method to be obtained for decorating products that uses decorating means that are suitable for being applied to a vast range of products to be fired at different temperatures by simply combining the decorating means with different flux substances to be applied separately. This enables stored decorating means and management of the decorating means to be reduced.

Furthermore, the method supplied by this aspect of the invention enables decorating means to be used wherein the flux substances do not take space away from other components and qualitatively relevant results can be obtained.

In a further preferred embodiment said coating of the flux substances occurs before said applying of the decorating means.

Advantageously, said coating comprises coating ceramic glaze on the products and if necessary subjecting said products to firing after coating them with ceramic glaze.

In a further preferred embodiment said coating of the flux substances occurs after said applying of the decorating means. Advantageously, said coating comprises coating a liquid ceramic glaze or a transparent frit or also glass grit particles that may be united by collodion, which perform the function of flux during firing.

In another further preferred embodiment said applying comprises applying the decorating means to support means such as a sheet and applying said support means to the products that are to be decorated.

Advantageously, the support means can be removed from the products before said firing or they can be of a decomposable type so as to decompose during said firing.

It is obvious that the method according to this aspect of the invention is provided with great flexibility, thereby lending itself to being used for a particularly wide range of products, for example ready-fired products or products to be fired, that have already been glazed or are to be glazed.

Certain embodiments of the invention will now be described by way of examples that do not limit the scope of the invention. The decorating means according to the invention comprise a toner, in other words a powder consisting of small particles, having a diameter comprised, for example, between 1 and 15 μm, containing a preset quantity of colouring pigments and of binding resin.

The colouring pigments are inorganic crystalline compounds that can withstand the high temperatures reached during firing without undergoing substantial alterations. For decorating ceramic or vitreous products pigments can be used comprising metals in a colloid dispersion such as Au, Ag, Se, Pt, Cu or cadmium sulphurs and cadmium sulphoselenides, in other words compounds in colloid form that are not constituted by oxides.

The colouring pigments may also comprise metallic oxides such as CuO, NiO, MnO, MnO₂, Fe₂O₃, Cr₂O₃, Co₃O₄, Al, Sn, V, Si, Ti, Pb, Zr, Zn oxides, or mixtures of oxides combined according to different crystalline structures, for example, spinel, olivine, pyrochlore, garnet, phenakite, periclase, zircon, baddeleyite, corundum, rutile, cassiterite, sphene structures.

The quantity in weight of the colouring pigments in the toner according to the invention may vary between 2% and 60% in weight, and be preferably comprised between 5% and 50% in weight. The dimensions of the particles of colouring pigments vary between 0.1 μm and 10 μm, and are preferably between 0.1 μm and 2 μm.

The binding resins are substances that are suitable for giving cohesion to colouring pigments so as to enable them to be worked and manipulated before firing. The binding substances that are normally used are thermoplastic resins such as polyamides, polyolefins, styrene acrylates, butadiene styrene, cross-linked styrene polymers, epoxy resins, polyurethanes, vinyl resins, possibly comprising homopolymers or copolymers of two or more vinyl monomers, polyesters, for example produced by the polymer esterification of a dicarboxylic acid and of a diol comprising a diphenol. Other binding resins comprise resins obtained from the reaction of the diphenol A and of the propylene oxide followed by the reaction of the resulting product with fumaric acid, or polyester resins obtained from the reaction of dimethyl terephthalate, 1,3 butanediol, 1,2 propanediol, or also extruded reactive resins, above all extruded cross-linked polyesters. The vinyl monomers used in the formulation of the binding resins include styrene, p-chlorostyrene, unsaturated mono-olefins such as ethylene, propylene, butylene, isobutylene and the like; saturated mono-olefins such as vinyl acetate, vinyl propionate and vinyl butyrate; vinyl esters of monocarboxylic acids comprising methylmethacrilate, ethylmethacrylate, and butylmethacrylate, acrylonitrile, acrylamide; mixtures thereof and the like; styrene-butadiene copolymers with a styrene content between 70% and 95%.

The binding resins are present in the toner according to the invention in quantities that vary between 20% and 99%, preferably between 30% and 90%.

Further substances that may be present in the toner are waxes such as polyethylene, polypropylene, paraffin, natural waxes, load-control agents and various additives.

The waxes are present in quantities that vary between 0.2% and 10%, preferably between 0.5% and 6%, whereas the load-control agents may vary between 0.2% and 1.8% in toner weight, and the additives between 0.3% and 3% for each additive.

However, no flux substances are contained in the toner composition according to the invention.

The toner that is thus identified can be used to decorate ceramic products, particularly tile or vitreous products, particularly glass slabs, by means of a digital printing process. Said process provides that the toner is deposited on a photoconductor roller only at set areas of said roller that form the image that is to be printed; this is possible because of the effect of electrostatic attraction and/or repulsion phenomena between the toner and selected areas of the photoconductor roller. The latter subsequently transfers the toner, according to the desired design, to the products that are to be decorated.

The digital printer used to decorate said products can be of the laser type or of the LED type; in the latter case it uses a matrix comprising a plurality of luminous diodes to create the image to be printed on the photoconductor roller. The LED technology used, for example, in an OKI printing system or the equivalent has the advantage of enabling high resolution combined with significant constructional simplicity inasmuch as there are no movable mechanisms for controlling the beams of light, as is required by laser printers.

The LED digital printers can operate according to different printing methods, a particularly advantageous method being the “tandem method”, which operates as a four-colour process and provides for using four separate printing stations, one for each colour, which by means of four different rollers transfer the images onto products moving below them. A heated melting roller melts the binding resin, enabling it to keep the particles of toner united according to the decorative motif that one wishes to transfer.

The products decorated with the toner according to the invention must be subjected to a firing process, which normally occurs at temperatures comprised between 800 and 1250° C. in order to fix the decoration by hardening it on the product surface.

In a first embodiment the toner is applied to tiles that are already covered by a layer of ceramic glaze. Said glaze may be fresh, in which case it is fired together with the toner, or it may be ready-fired, if the tile has been previously fired, and in this case it melts again during said firing process. In both cases the ceramic glaze behaves like a flux in relation to the toner, in other words, as it is in a molten state because of the high firing temperatures it incorporates inside itself the decoration created by the toner and during solidification during subsequent cooling it fixes it on the surface of the tile.

In a second embodiment the decorative motif produced with the toner is applied to an unglazed ceramic product, and said decorative motif is coated with a layer of particles of glass grit possibly united by means of collodion, or a layer of liquid glaze or yet again a layer of transparent frit.

During said firing process, the particles of glass grit, or the liquid glaze, or the transparent frit melt and act as a flux for the toner, because the molten mass that they form incorporates inside itself the colouring pigments contained in the toner and fixes them on the surface of the tile during solidification.

This second embodiment enables aesthetic effects to be obtained that are different from cases in which the glaze is underneath the decorative motif created with the toner; in fact, if the decorative motif is covered by a top layer, however constituted, its surroundings will tend to appear shaded.

The two embodiments described above apply the toner directly to the surface of the product that is to be decorated; on the other hand, a third alternative embodiment applies a decoration to the products comprising an ornamental motif created with the toner on a support means, for example a sheet of paper coated with wax, or polyvinyl acetate, or Arabic gum, which is in turn coated on the tile. The support sheet can be removed before firing, by detaching it from the decorative motif by means of peeling so as to leave the decorative motif on the product surface, or can be left on the product to decompose when it is subjected to high firing temperatures.

The decoration can also include the flux substances, for example in the form of dry ceramic glaze or of particles of glass grit possibly united by means of collodion, applied separately from the toner that forms the decorative motif.

In fact, even if a decoration is used that is obtained by applying a decorative motif created with the toner that has no flux substances on a support sheet, it is necessary to apply a substance separately from the toner that is able to behave as a flux, for example in one of the ways described in the first and second embodiments.

1. Decorating means for ceramic or vitreous products, that is suitable for being applied to said products by means of digital printing techniques, comprising colouring means that is suitable for colouring said decorating means, binding means that is suitable for keeping said colouring means united, characterised in that said decorating means has no flux substances.

2. Decorating means according to claim 1, wherein said flux substances are associated with said decorating means on said products.

3. Decorating means according to claim 1, or 2, wherein said flux substances are applied to said products before said decorating means.

4. Decorating means according to claim 1, or 2, wherein said flux substances are applied to said products after said decorating means.

5. Decorating means according to any one of the previous claims, wherein said flux substances comprise ceramic glaze.

6. Decorating means according to claim 5, wherein said ceramic glaze is in an fired state, when said decorating means are applied to said products.

7. Decorating means according to claim 5, wherein said ceramic glaze is in an unfired state, when said decorating means are applied to said products.

8. Decorating means according to any one of the previous claims, wherein said flux substances comprise particles of glass grit, possibly united by means of collodion.

9. Decorating means according to any one of the previous claims, wherein said flux substances comprise transparent frit.

10. Decorating means according to any one of the previous claims, wherein said decorating means are associated with support means that are suitable for receiving said decorating means and transferring them to said products.

11. Decorating means according to claim 10, wherein said support means comprise a sheet of paper.

12. Decorating means according to claim 10, or 11, wherein said support means can decompose at relatively high temperatures.

13. Decorating means according to claim 10, or 11, wherein said support means can be peeled off said decorating means.

14. Decorating means according to any one of the previous claims, wherein said decorating means are processed by laser digital printing devices.

15. Decorating means according to any one of claims 1 to 13, wherein said decorating means are processed by means of LED-type digital printing devices.

16. Decorating means according to claim 15, wherein said LED-type digital printing devices use a “tandem” method.

17. Decorating means according to any one of the previous claims, wherein said colouring means have granulometry between 0.1 μm and 10 μm, preferably comprised between 0.1 μm and 2 μm.

18. Decorating means according to any one of the previous claims, wherein said colouring means are present in quantities varying between 2% and 60% in weight of said decorating means, and preferably in a quantity varying between 5% and 50% in weight of said decorating means.

19. Decoration for decorating ceramic or vitreous products, comprising decorative motif means applied to support means by means of digital printing techniques characterised in that said decorative motif means are created with decorating means that have no flux substances.

20. Decoration according to claim 19, wherein said decorating means comprise colouring means that are suitable for colouring said decorating means, and binding means that are suitable for keeping said colouring means united.

21. Decoration according to claim 20, wherein said colouring means have granulometry between 0.1 μm and 10 μm, preferably comprised between 0.1 μm and 2 μm.

22. Decoration according to claim 20, or 21, wherein said colouring means are present in quantities varying between 2% and 60% in weight of said decorating means, and preferably in a quantity varying between 5% and 50% in weight of said decorating means.

23. Decoration according to any one of claims 19 to 22, and furthermore comprising said flux substances, which are applied to said decoration separately from said decorating means.

24. Decoration according to claim 23, wherein said flux substances comprise particles of glass grit, possibly united by means of collodion.

25. Decoration according to any one of claims 19 to 24, wherein said support means comprise a sheet of paper.

26. Decoration according to any one of claims 19 to 25, wherein said support means can decompose at relatively high temperatures.

27. Decoration according to any one of claims 19 to 25, wherein said support means can be peeled off said decorative motif means.

28. Decoration according to any one of claims 19 to 27, wherein said digital printing techniques use laser-type digital printing devices.

29. Decoration according to any one of claims 19 to 27, wherein said digital printing techniques use LED-type digital printing devices.

30. Decoration according to claim 29, wherein said LED-type digital printing devices use a “tandem” method.

31. A method for decorating ceramic or vitreous products by means of digital printing techniques, comprising applying decorating means to said products, said decorating means comprising colouring means that are suitable for colouring said decorating means and binding means that are suitable for keeping said colouring means united, characterised in that said decorating means have no flux substances.

32. A method according to claim 31, and furthermore comprising coating said flux substances on said products.

33. A method according to claim 32, wherein said coating occurs before said applying.

34. A method according to claim 32, wherein said coating occurs after said applying.

35. A method according to any one of claims 32 to 34, wherein said coating comprises coating ceramic glaze on said products.

36. A method according to claim 35, and furthermore comprising, before said applying, subjecting said products to firing on which said ceramic glaze has been coated.

37. A method according to any one of claims 32 to 36, wherein said coating comprises coating particles of glass grit, which are possibly united by means of collodion, onto said products.

38. A method according to any one of claims 32 to 37, wherein said coating comprises coating trasparent frit onto said products.

39. A method according to any one of claims 31 to 38, wherein said applying comprises applying said decorating means to support means that are suitable for receiving said decorating means and transferring them to said products.

40. A method according to claim 39, wherein said support means comprise a sheet of paper.

41. A method according to claim 39, or 40, and furthermore comprising thermally decomposing said support means.

42. A method according to claim 39, or 40, and furthermore comprising separating said support means from said decorating means.

43. A method according to any one of claims 31 to 42, wherein said applying occurs by means of laser-type digital printing devices.

44. A method according to any one of claims 31 to 42, wherein said applying occurs by means of LED-type digital printing devices.

45. A method according to claim 44, wherein said digital printing devices use a “tandem” method.
